(19) United States
(12) Patent Application Publication
(10) Pub. No.: US 2012/0078941 A1
(43) Pub. Date: Mar. 29, 2012

(54) QUERY ENHANCEMENT APPARATUS, METHODS, AND SYSTEMS

(75) Inventors: Marcus Philip Tidwell, North Royalton, OH (US); Leslie J. Mannion, Cary, NC (US)

(73) Assignee: Teradata US, Inc., Miamisburg, OH (US)

(21) Appl. No.: 12/890,828

(22) Filed: Sep. 27, 2010

(51) Int. Cl. G06F 17/30

(52) U.S. Cl. 707/769; 707/E17.069

(57) ABSTRACT

Apparatus, systems, and methods may operate to receive user-specified input data from a user input device as a segment query that includes a plurality of criteria, and to store individual counts and at least one additional count in a storage medium. The individual counts are derived from processing the segment query as a corresponding plurality of queries associated with each of the criteria, and the at least one additional count comprises an intersection of at least two of the criteria, regardless of whether the user-specified input data includes an intersection operation. Other apparatus, systems, and methods are disclosed.

### COPYRIGHT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever. The following notice applies to the example code, screen shots, and images described below, and in any drawings appended hereto: Copyright© 2010 Teradata, Inc. of Miamisburg, Ohio—All Rights Reserved.

### BACKGROUND

It is not uncommon to see the amount of data associated with a business venture grow at an exponential pace. To keep track of this ever-growing amount of information, the data is often stored in one or more databases, so that queries can be developed to mine the data. In most database systems, when the user wants to know the effects of changing a logical operator on various search criteria within a given query, the operator is manually altered within the user interface, and the query is re-submitted to determine the effect. Obtaining this new query result thus takes extra time and storage to accomplish.

### BRIEF DESCRIPTION OF THE DRAWINGS

FIG. 1 illustrates the generation and storage of enhanced query results according to various embodiments of the invention.

FIG. 2 is a flow diagram illustrating several methods of query enhancement according to various embodiments of the invention.

FIG. 3 is a block diagram of apparatus and systems according to various embodiments of the invention.

FIG. 4 is a block diagram of an article of manufacture, including a specific machine, according to various embodiments of the invention.

### DETAILED DESCRIPTION

To enhance operational efficiency, as well as to address some of the other challenges described above, many embodiments operate to enhance query performance by storing information that can be used to provide query results other than those specifically requested by the user. While this mode of operation might seem to increase the storage associated with a particular query, it turns out that the amount of storage used in most instances is substantially the same as that used in conventional systems, and that the query results actually requested by the user can be calculated from what is stored, without executing additional queries. In other words, by storing different data, a single query can be enhanced to provide additional results, without running additional queries.

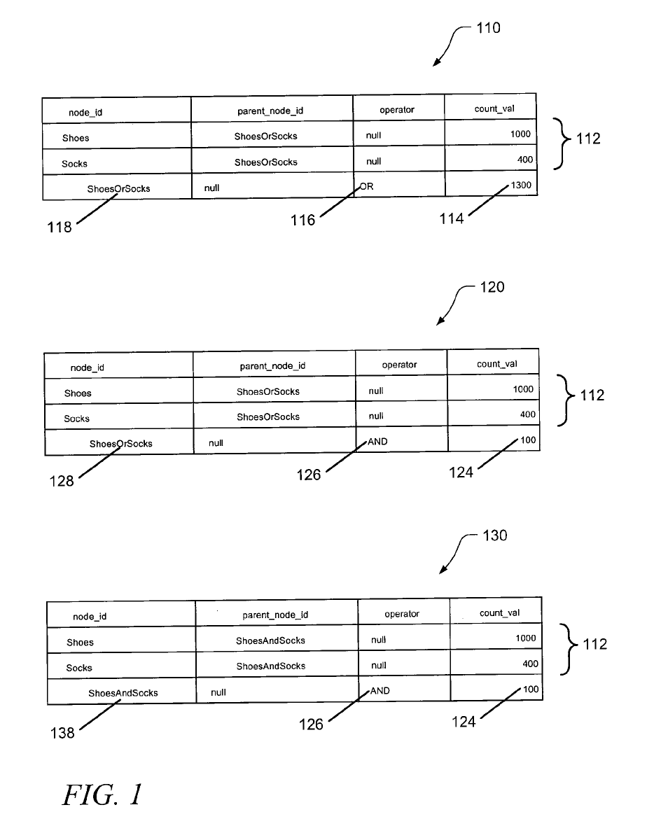

FIG. 1 illustrates the generation and storage of enhanced query results according to various embodiments of the invention. For the purposes of this document, the term “insight counts” will be used to refer to a concept that demonstrates the effects of certain criteria on a segment of data. Insight counts are counts of individual criteria within a logical group, as well as the counts determined when each criterion is logically added to form a larger group. For example, a segment of data might be defined as people who have purchased shoes over the last twelve months, and who have also purchased socks over this same time period. The associated insight counts might show the count of each criterion (i.e., shoes, and socks), as well as the count of one or more logical combinations of these criteria (e.g., shoes AND socks, shoes OR socks).

For this example, assume that a database includes the following information:

1000 people purchased shoes over the last 12 months.

400 people purchased socks over the last 12 months.

100 people purchased shoes AND socks over the last 12 months.

In addition to these results, it might be useful to know the count of people who purchased shoes OR socks over the last twelve months. It turns out that this number can be determined using only the information listed above, without making an additional query. Thus, in many embodiments, the ability to calculate a new count based on a set of prior query count results can be advantageous—computation can be used to save time and/or storage space that might otherwise be used without the benefit of making the calculation.

In prior systems, insight counts 110 would be used to store the count for each criterion making up the user-input data, along with each connecting point of the criterion. Changing logical operators would imply changing the user-input data, and making additional queries. However, as part of many embodiments, the user may revise the search query results in an interactive manner, without many additional queries. This is enabled by changing the way in which criteria level results are stored.

To implement various embodiments, it should be noted that set logic provides a solution to calculate the count of people who purchased either shoes OR socks over the last twelve months when the count of people who purchased shoes AND socks is known:

C(“or”)=C(shoes)+C(socks)−C(“and”).

1300=1000+400−100.

Thus, if the count associated with the intersection of criteria (e.g., the AND count) is always stored, even when the user-input data shows that the user has selected OR as the operative logical operation, both the AND and OR results can be provided, while storing only the count associated with the AND operation. Thus, if only the OR result is desired, the calculation can be employed, and the count resulting from the calculation is displayed. If the AND result is desired, the stored AND count can be displayed. In this way, the system can report counts for both AND and OR query options knowing only the three counts listed above (e.g., COUNTₛₕₒₑₛ, COUNT_{socks}, and COUNTₛₕₒₑₛAND_{socks}). Thus, the AND count may be stored, regardless of the user's selection of a criteria operator.

Turning to FIG. 1, it can be seen that in the conventional process, when the user-specified input data (e.g., segment query) 118 of Shoes OR Socks is received for the criteria (Shoes, Socks), then the individual counts 112 for each of Shoes and Socks are stored in the table 110, along with the count 114 for the OR operation 116 (obtained by running a query based on the OR operation). At this point, if the user wants to know the effect of changing the logical operator in the user-input data 118 from an OR operator 116 to an AND operator 126, the user-specified input data 118 would be changed to reflect the presence of the new operator, and a new query would be executed (based on the AND operation).

However, when implementing many embodiments of the invention, when the user submits the user-specified input data (e.g., segment query) 128 of Shoes OR Socks for the criteria (Shoes, Socks), then the individual counts 112 for Shoes and Socks will be stored in the table 120, along with the count 124 for the AND operation 126 (even though an OR operation was requested by the user). The count 114 resulting from the OR operation can be obtained by calculation, using the stored counts 112, 124, as described previously. Thus, there is no need to store the count 114 resulting from the OR operation in the table 120.

At this point, if the user wants to know the effect of changing the OR operator in the user-specified input data 128 to an AND operator 126, the user-specified input data 128 does not need to be changed, and no new query is executed, because the count 124 for the AND operation 126 has already been saved. The additional count associated with the AND operation can simply be recalled and reported.

Individual counts associated with each criterion, along with the count resulting from a logical combination of at least two of the criteria (e.g., using the logical AND operator), can be stored in a database table 120, perhaps on a server, or in a separate storage node.

This mode of operation provides a “zero storage cost” interactive calculation to provide the OR result. Thus, as noted in the table 130, when the user-specified input data 138 includes AND as a logical operator 126, the count 124 resulting from executing the query using the AND operator 126 is stored. The count 114 resulting from using the OR logical operator 116 can be calculated, and reported, if desired.

In summary, prior to employing various embodiments of the invention, the ability to view counts from altered operators might have required extra storage space, or running additional queries. Now, altered operators can be employed via calculation, rather than using additional queries and storage. This enables more efficient generation of interactive queries.

Thus, many embodiments of the invention may be realized, and each can be implemented in a variety of architectural platforms, along with various operating and server systems, devices, and applications. Any particular architectural layout or implementation presented herein is therefore provided for purposes of illustration and comprehension only, and is not intended to limit the various embodiments.

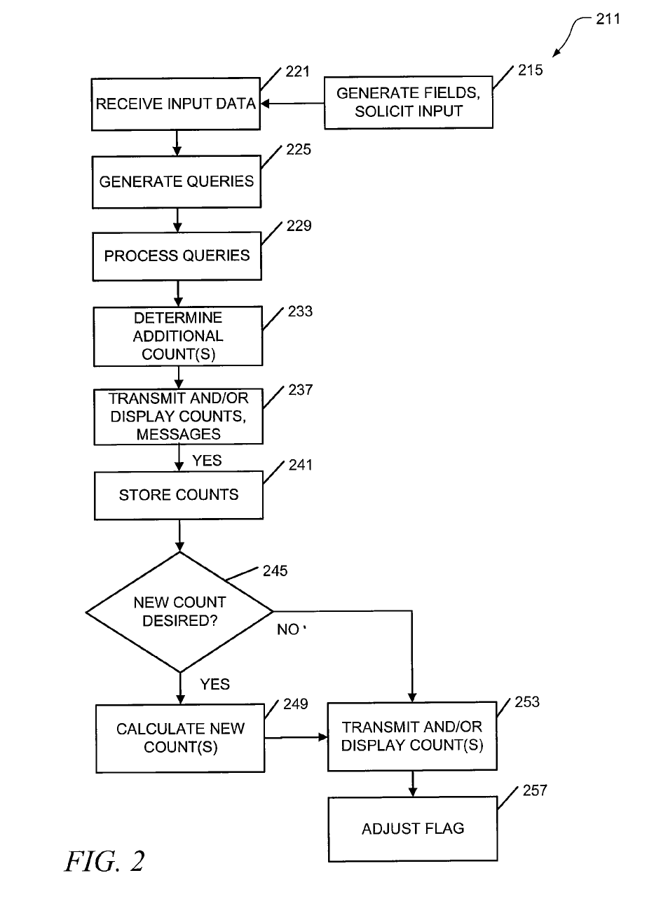

FIG. 2 is a flow diagram illustrating several methods 211 of query enhancement according to various embodiments of the invention. The methods 211 are implemented in a machine-accessible and readable medium, and are operational over processes within and among networks. The networks may be wired, wireless, or a combination of wired and wireless. The methods 211 may be implemented as instructions, which when accessed by a specific machine, perform the processing depicted in FIG. 2.

In some embodiments, the method 211 may comprise a processor-implemented method to execute on one or more processors that perform the method. In many embodiments, query fields can be displayed on a user input device, and user-specified input (e.g., a segment query) can be requested using the fields. Thus, the method 211 may begin at block 221 with generating a set of query fields to be published on a user input device comprising a human-readable display, and then soliciting the user-specified input using the query fields.

In response to the solicitation, the user may enter a query to provide user-specified input data. Thus, the method 111 may continue on to block 221 with receiving user-specified input data from a user input device as a segment query that includes a plurality of criteria. In the case of the example discussed previously, the user-specified input data might comprise “people who have purchased shoes or socks over the last twelve months”, where the included criteria include “shoes” and “socks”.

Once the user-specified input data is received, including a plurality of criteria, multiple queries can be generated. Thus, the method 211 may continue on to block 225 with generating a plurality of queries derived from user-specified input data that includes a corresponding plurality of criteria.

Each of the generated queries can be processed. Thus, the method 211 may continue on to block 229 with processing the plurality of queries to provide individual counts corresponding to each of the criteria. Referring to the previous example, the individual counts for the queries corresponding to “shoes” and “socks” are 1000 and 400, respectively.

Thus, individual counts may correspond to consumer purchasing behavior, such as product purchase counts comprising the quantities of selected products purchased over a selected time period (e.g., number of cars bought in one day, pounds of lettuce purchased in one month, etc.). Of course, the counts may correspond to any number of quantities that can be measured, whether related to a selected period of time or not (e.g., the number of atoms in a water molecule).

Logical combinations of the criteria can be made, to assist in generating additional queries (if needed), and determining additional counts. Thus, the method 211 may continue on to block 233 to include determining at least one additional count based on a logical combination of at least two of the criteria, the logical combination comprising an operation between the criteria that is not included in the user-specified input data.

This specific case was demonstrated in the example above, where it was determined that 100 people purchased shoes AND socks over the last 12 months (when the user-specified input data included an OR logical operator). That is, an OR logical operator, present in the user-specified input data, may be exchanged for a logical AND operator to provide the additional count (e.g., 100 in the example). Thus, the operation between the criteria may comprise an AND logical operator, substituted for an OR logical operator that was originally included in the user-specified input data.

Several additional count values may be determined in this manner. The number of additional count values determined may be equal to the number of individual counts, minus one. Thus, the number of the additional counts may comprise the number of criteria, less one.

Once the individual counts and additional counts are determined, they can be published, perhaps by storing them or by making them visible. Thus, the method 211 may continue on to block 237 with transmitting the individual counts and at least one additional count to a storage medium and/or a human-readable display.

The user may be presented with the results of queries based on the user-specified input data, including an OR operation, with the option of viewing one or more additional counts as the result of a query that includes an AND operation. Thus the activity at block 237 may comprise transmitting to the human-readable display, when the user-specified input data comprises an OR operation, the new count (as a result of the OR operation) and an option to display the at least one additional count (as the result of an AND operation).

In some embodiments, the user can be asked whether they want to see a “what-if” analysis (e.g., a display of the count associated with an OR operator when an AND operator is included in the user-specified input data, or conversely, a display of the count associated with an AND operator when an OR operator is included in the user-specified input data). Thus, in some cases, the activity at block 237 may comprise transmitting a message to the user input device, requesting input as to whether additional counts should be displayed on the user input device.

The counts (i.e., individual counts, additional counts) can all be stored. Thus, in some embodiments the method 211 may continue on to block 241 with storing individual counts and at least one additional count in a storage medium. In some cases, the individual counts are derived from processing the segment query as a corresponding plurality of queries associated with each of the criteria, as described above, where the at least one additional count comprises an intersection of at least two of the criteria, regardless of whether the user-specified input data includes an intersection operation.

The activity at block 241 may also comprise storing the counts in a table, such as a simple table, a multi-dimensional table, wide and narrow tables, etc. The counts may also be stored in a tabular data structure, such as a table, comma-separated values, etc.

At block 245, a determination can be made as to whether another kind of count, called a “new count” is desired. This count is calculated from stored counts. An example of this is the count associated with the OR operation included in the user-specified input data of the example above: C(“or”)=C(shoes)+C(socks)−C(“and”)=1300. Thus, for example, when an OR logical operator is present in the user-specified input data, the new count associated with the operator may be determined as a new logical combination, by a calculation that makes use of the stored additional count (provided by using the AND logical operator), without running an additional query of the database.

If the new count is not needed, then the method 211 may continue on to block 253. Otherwise, the method 211 may continue on to block 249 with calculating a new count associated with a new logical combination of at least two criteria based on at least one additional count. The new logical combination may comprise, for example, a union of at least two of the criteria, such that the calculation is accomplished without processing an additional query of a database comprising the individual counts. In other words, the union of criteria can sometimes be calculated, based on stored criteria intersection information, without sending an additional query to the database.

At block 253, one or more of the counts may be displayed, including individual counts, additional counts, and/or new counts. In some embodiments, the user may be presented with a “what-if” scenario that includes both AND and OR logical combinations of individual counts. Thus, the activity at block 237 may comprise transmitting a what-if scenario to the human-readable display, including one or more new counts and additional counts. The new counts can be transmitted and displayed as part of the activity at block 253.

In some embodiments, the results of the original query provided by the user in the form of user-specified input data (e.g., that includes an OR operation), along with the results of a query using an AND operation (that was not present in the original query) can be published to the user as part of the default query-response operations, without asking for preferences. Thus, the activity at block 253 may comprise publishing to the user input device, as a default condition, the individual counts, at least one additional count (e.g., provided by an intersection of criteria), and a new count associated with a union of the criteria.

In some embodiments, a flag can be set so that both the union and intersection of the count values are always displayed. Thus, the method 211 may include, at block 257, adjusting a flag value to indicate that the activity of transmitting (at blocks 237 and/or 253) is to include the individual counts and at least one additional count, in conjunction with a new count associated with a new logical combination of the criteria based on the additional count. The new logical combination may comprise a union of some of the criteria.

The methods described herein do not have to be executed in the order described, or in any particular order. Moreover, various activities described with respect to the methods identified herein can be executed in repetitive, serial, or parallel fashion. The individual activities of the methods shown in FIG. 2 can also be combined with each other and/or substituted, one for another, in various ways. Information, including parameters, commands, operands, and other data, can be sent and received in the form of one or more carrier waves. Thus, many other embodiments may be realized.

The methods shown in FIG. 2 can be implemented in various devices, as well as in a computer-readable storage medium, where the methods are adapted to be executed by one or more processors. Further details of such embodiments will now be described.

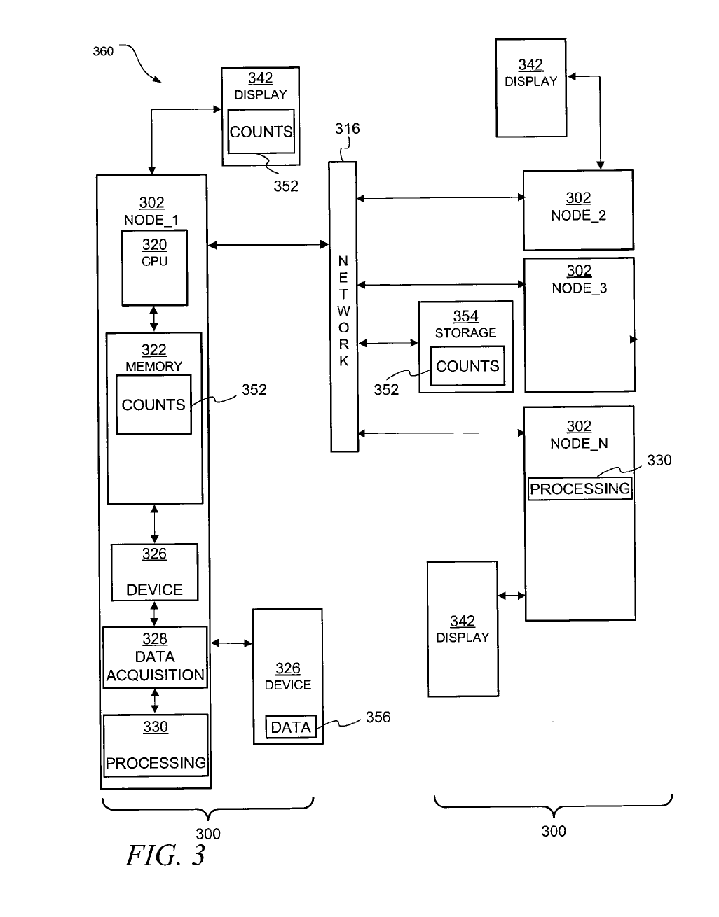

FIG. 3 is a block diagram of apparatus 300 and systems 360 according to various embodiments of the invention. Here it can be seen that an apparatus 300 used to implement query enhancement may comprise one or more processing nodes 302, one or more processors 320, memories 322, one or more user input devices 326, a data acquisition module 328, a processing module 330, and one or more displays 342. The apparatus 300 may comprise a client, a server, or a networked processing node.

The processing nodes 302 may in turn comprise physical machines or virtual machines, or a mixture of both. The nodes 302 may also comprise networked entities, such servers and/or clients. In some cases, the operations described herein can occur entirely within a single node 302.

In some embodiments then, an apparatus 300 may comprise a data acquisition module 328 to receive user-specified input data 356 including a plurality of criteria. The apparatus 300 may further comprise a processing module 330 to generate a plurality of queries derived from the user-specified input data, and to process the plurality of queries to provide individual counts corresponding to each of the criteria. The processing module 330 may further operate to determine at least one additional count based on a logical combination of at least two of the criteria, as described previously, and to transmit the individual counts and the at least one additional count to a storage medium (e.g., storage node 354).

The apparatus may include a display, or be coupled to a remote display. Thus, the apparatus 300 may comprise one or more human-readable displays 342 to display the individual counts and the additional count(s).

The apparatus may include a user input device (e.g., keyboard or touchscreen) to supply one or more segment queries. Thus, the apparatus 300 may comprise one or more user input devices 326 to provide the user-specified input data 356.

Processing of the segment query may be divided between various nodes. Thus, the apparatus 300 may comprise a first node (e.g., NODE_1) to house the data acquisition module 328, and a second node (e.g., NODE_N) to house the processing module 330.

The apparatus may be coupled to a separate storage node. Thus, the apparatus 300 may comprise a storage node 354 to house the storage medium (e.g., a memory 322) in which the counts 352 are stored.

Still further embodiments may be realized. For example, it can be seen that a system 360 that operates to implement query enhancement may comprise multiple instances of the apparatus 300. The system 360 might also comprise a cluster of nodes 302, including physical and virtual nodes. It should be noted that any of the nodes 302 may include any one or more of the elements explicitly shown in nodes NODE_1, NODE_2, NODE_3, . . . NODE_N.

The apparatus 300 and systems 360 may be implemented in a machine-accessible and readable medium that is operational over one or more networks 316. The networks 316 may be wired, wireless, or a combination of wired and wireless. The apparatus 300 and system 360 can be used to implement, among other things, the processing associated with the methods 211 of FIG. 2. Modules may comprise hardware, software, and firmware, or any combination of these. Additional embodiments may be realized.

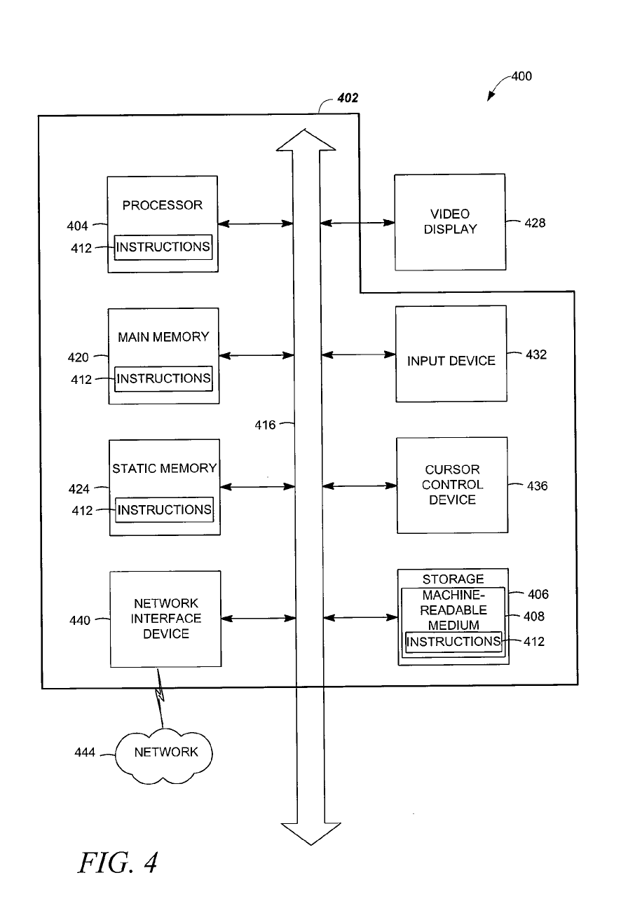

For example, FIG. 4 is a block diagram of an article 400 of manufacture, including a specific machine 402, according to various embodiments of the invention. Upon reading and comprehending the content of this disclosure, one of ordinary skill in the art will understand the manner in which a software program can be launched from a computer-readable medium in a computer-based system to execute the functions defined in the software program.

One of ordinary skill in the art will further understand the various programming languages that may be employed to create one or more software programs designed to implement and perform the methods disclosed herein. The programs may be structured in an object-oriented format using an object-oriented language such as Java or C++. Alternatively, the programs can be structured in a procedure-oriented format using a procedural language, such as assembly or C. The software components may communicate using any of a number of mechanisms well known to those of ordinary skill in the art, such as application program interfaces or interprocess communication techniques, including remote procedure calls. The teachings of various embodiments are not limited to any particular programming language or environment. Thus, other embodiments may be realized.

For example, an article 400 of manufacture, such as a computer, a memory system, a magnetic or optical disk, some other storage device, and/or any type of electronic device or system may include one or more processors 404 coupled to a machine-readable medium 408 such as a memory (e.g., removable storage media, as well as any memory including an electrical, optical, or electromagnetic conductor) having instructions 412 stored thereon (e.g., computer program instructions), which when executed by the one or more processors 404 result in the machine 402 performing any of the actions described with respect to the methods above.

The machine 402 may take the form of a specific computer system having a processor 404 coupled to a number of components directly, and/or using a bus 416. Thus, the machine 402 may be similar to or identical to the apparatus 300 or system 360 shown in FIG. 3.

Turning now to FIG. 4, it can be seen that the components of the machine 402 may include main memory 420, static or non-volatile memory 424, and mass storage 406. Other components coupled to the processor 404 may include an input device 432, such as a keyboard, or a cursor control device 436, such as a mouse. An output device 428, such as a video display, may be located apart from the machine 402 (as shown), or made as an integral part of the machine 402.

A network interface device 440 to couple the processor 404 and other components to a network 444 may also be coupled to the bus 416. The instructions 412 may be transmitted or received over the network 444 via the network interface device 440 utilizing any one of a number of well-known transfer protocols (e.g., HyperText Transfer Protocol). Any of these elements coupled to the bus 416 may be absent, present singly, or present in plural numbers, depending on the specific embodiment to be realized.

The processor 404, the memories 420, 424, and the storage device 406 may each include instructions 412 which, when executed, cause the machine 402 to perform any one or more of the methods described herein. In some embodiments, the machine 402 operates as a standalone device or may be connected (e.g., networked) to other machines. In a networked environment, the machine 402 may operate in the capacity of a server or a client machine in server-client network environment, or as a peer machine in a peer-to-peer (or distributed) network environment.

The machine 402 may comprise a personal computer (PC), a tablet PC, a set-top box (STB), a PDA, a cellular telephone, a web appliance, a network router, switch or bridge, server, client, or any specific machine capable of executing a set of instructions (sequential or otherwise) that direct actions to be taken by that machine to implement the methods and functions described herein. Further, while only a single machine 402 is illustrated, the term “machine” shall also be taken to include any collection of machines that individually or jointly execute a set (or multiple sets) of instructions to perform any one or more of the methodologies discussed herein.

While the machine-readable medium 408 is shown as a single medium, the term “machine-readable medium” should be taken to include a single medium or multiple media (e.g., a centralized or distributed database, and/or associated caches and servers, and or a variety of storage media, such as the registers of the processor 404, memories 420, 424, and the storage device 406 that store the one or more sets of instructions 412). The term “machine-readable medium” shall also be taken to include any medium that is capable of storing, encoding or carrying a set of instructions for execution by the machine and that cause the machine 402 to perform any one or more of the methodologies of the present invention, or that is capable of storing, encoding or carrying data structures utilized by or associated with such a set of instructions. The terms “machine-readable medium” or “computer-readable medium” shall accordingly be taken to include tangible media, such as solid-state memories and optical and magnetic media.

Various embodiments may be implemented as a stand-alone application (e.g., without any network capabilities), a client-server application or a peer-to-peer (or distributed) application. Embodiments may also, for example, be deployed by Software-as-a-Service (SaaS), an Application Service Provider (ASP), or utility computing providers, in addition to being sold or licensed via traditional channels.

Implementing the apparatus, systems, and methods described herein may operate to reduce the number of queries that are executed on a given database. In addition, the efficiency of segment creation may be improved, enabling users to spend more time constructing “what-if” scenarios that are used to help identify segment criteria that are useful in specific markets.

In some cases, the user may identify the attributes they wish to analyze, run a single query, and then interactively modify operators and query order to see different results (without running additional queries). Thus, database processing customers can expand result counts for segment criteria waterfall counts, visualizing the effects of logical operator changes, parentheses, and order—without increasing storage in many cases. Increased efficiency and user satisfaction may result.

This Detailed Description is illustrative, and not restrictive. Many other embodiments will be apparent to those of ordinary skill in the art upon reviewing this disclosure. The scope of embodiments should therefore be determined with reference to the appended claims, along with the full scope of equivalents to which such claims are entitled.

The Abstract of the Disclosure is provided to comply with 37 C.F.R. §1.72(b) and will allow the reader to quickly ascertain the nature of the technical disclosure. It is submitted with the understanding that it will not be used to interpret or limit the scope or meaning of the claims.

In this Detailed Description of various embodiments, a number of features are grouped together in a single embodiment for the purpose of streamlining the disclosure. This method of disclosure is not to be interpreted as an implication that the claimed embodiments have more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. An apparatus, comprising:
a data acquisition module to receive user-specified input data including a plurality of criteria; and
a processing module to generate a plurality of queries derived from the user-specified input data, to process the plurality of queries to provide individual counts corresponding to each of the criteria, to determine at least one additional count based on a logical combination of at least two of the criteria, the logical combination comprising an operation between the at least two of the criteria that is not included in the user-specified input data, and to transmit the individual counts and the at least one additional count to a storage medium.

2. The apparatus of claim 1, further comprising:
a human-readable display to display the individual counts and the at least one additional count.

3. The apparatus of claim 1, further comprising:
a user input device to provide the user-specified input data.

4. The apparatus of claim 1, further comprising:
a first node to house the data acquisition module; and
a second node to house the processing module.

5. The apparatus of claim 1, further comprising:
a storage node to house the storage medium.

6. A processor-implemented method to execute on one or more processors that perform the method, comprising:
generating a plurality of queries derived from user-specified input data that includes a corresponding plurality of criteria;
processing the plurality of queries to provide individual counts corresponding to each of the criteria;
determining at least one additional count based on a logical combination of at least two of the criteria, the logical combination comprising an operation between the at least two of the criteria that is not included in the user-specified input data; and
transmitting the individual counts and the at least one additional count to at least one of a storage medium or a human-readable display.

7. The method of claim 6, further comprising:
storing the individual counts and the at least one additional count in a table.

8. The method of claim 6, wherein the operation comprises an AND logical operator, substituted for an OR logical operator included in the user-specified input data.

9. The method of claim 6, further comprising:
calculating a new count associated with a new logical combination of the at least two criteria based on the at least one additional count, the new logical combination comprising a union of the at least two of the criteria, the calculating accomplished without processing an additional query of a database comprising the individual counts.

10. The method of claim 9, wherein the transmitting comprises:
transmitting to the human-readable display, when the user-specified input data comprises an OR operation, the new count and an option to display the at least one additional count as the result of an AND operation.

11. The method of claim 9, further comprising:
transmitting a what-if scenario to the human-readable display, the scenario to include the new count and the at least one additional count.

12. The method of claim 6, wherein a number of the at least one additional count comprises a number of the criteria, less one.

13. The method of claim 11, further comprising:
adjusting a flag value to indicate that the transmitting is to include the individual counts and the at least one additional count, in conjunction with a new count associated with a new logical combination of the criteria based on the at least one additional count, the new logical combination comprising a union of the at least two of the criteria.

14. The method of claim 6, wherein the individual counts correspond to product purchase counts over a selected time period.

15. A processor-implemented method to execute on one or more processors that perform the method, comprising:
receiving user-specified input data from a user input device as a segment query that includes a plurality of criteria; and
storing individual counts and at least one additional count in a storage medium, wherein the individual counts are derived from processing the segment query as a corresponding plurality of queries associated with each of the criteria, and wherein the at least one additional count comprises an intersection of at least two of the criteria, regardless of whether the user-specified input data includes an intersection operation.

16. The method of claim 15, further comprising:
generating a set of query fields to be published on the user input device comprising a human-readable display; and
soliciting the user-specified input using the query fields.

17. The method of claim 15, further comprising:
transmitting a message to the user input device, requesting input as to whether the at least one additional count should be displayed on the user input device.

18. The method of claim 15, further comprising:
publishing to the user input device, as a default condition, the individual counts, the at least one additional count, and a count associated with a union of the criteria.

19. The method of claim 15, wherein the storing comprises:
storing the individual counts and the at least one additional count in a tabular data structure.

20. The method of claim 15, further comprising:
calculating a new count associated with a new logical combination of the criteria based on the at least one additional count, the new logical combination comprising a union of at least two of the criteria, the calculating accomplished without processing an additional query of a database comprising the individual counts.
